(19) United States
(12) Patent Application Publication
(10) Pub. No.: US 2003/0219542 A1
(43) Pub. Date: Nov. 27, 2003

(54) Method of forming dense coatings by powder spraying

(76) Inventors: Frank J. Ewasyshyn, Rochester, MI (US); Alexandre I. Kachirine, Kaluga Region (RU); Alexander V. Shkidkin, Kaluga Region (RU); Oleg F. Kliouev, Kaluga Region (RU); Timour V. Bouzdygar, Kaluga Region (RU); Roman Gr. Maev, Windsor (CA); John M. Paille, AddisonTownship, MI (US); Emil E. Strumban, Oak Park, MI (US)

Correspondence Address: Donald J. Wallace, DaimlerChrysler Intellectual Capital Corporation, CIMS 483-02-19, 800 Chrysler Drive, Auburn Hills, MI, 48326-2757, US

(21) Appl. No.: 10/442,325

(22) Filed: May 21, 2003

Related U.S. Application Data
(60) Provisional application No. 60/382,950, filed on May 25, 2002.

(51) Int. Cl. B05D 1/12

(52) U.S. Cl. 427/421; 427/180

(57) ABSTRACT

A dense coating deposition process by powder spraying is disclosed. A compressed gas is expanded through a supersonic nozzle and powder containing a mixture of at least one material selected from the group consisting of metals and metal alloys and at least one ceramic material is introduced into the gas flow slightly downstream of the throat of the nozzle. The coating is formed by the powder impacting and metallurgically bonding to the substrate and can be applied in multiple layers. The coating can suffice as a finished surface, corrosion protectant, leak sealer, and material build up application.

### CROSS-REFERENCE TO RELATED APPLICATIONS

This application claims the benefit of U.S. Provisional Application No. 60/382,950, filed May 25, 2002.

### FIELD OF THE INVENTION

The present invention relates to the method of applying a coating to automotive articles and body panel joints using gas dynamic spraying.

### BACKGROUND OF THE INVENTION

Protecting material surfaces as well as their restoration is a concern in many industries. Coatings can be grouped according to their applications such as corrosion and wear resistance, surface and dimension restoration, net shape forming, leakage sealing, etc. Many applications of coating require their compatibility with further finishing and painting. Specialized deposition methods and coating compositions have been developed to address these applications with some success. The typical prior art method uses a wire arc spraying method such as disclosed in U.S. Pat. No. 6,001,426.

In the automotive industry, corrosion protection of folded hem flanges that couple inner and outer body panels, such as door panels, is a common practice and the subject of ongoing research. When assembling an automobile, an adhesive is used to attach the panels to one another and also to provide a sealing effect. The common method of sealing a folded hem flange utilizes multiple polymeric beads of flowable sealants or two separate sealing materials such as a bead of flowable sealant and a heat curable paint. However, micropores can form in the sealer during temperature curing which can lead to moisture penetration and eventually to corrosion of the hem flange.

Another critically important area affecting the aesthetics of car body panels are lap joint seams that are formed when an edge portion of one sheet is placed in overlapping fashion against an edge portion of another sheet. Using a conventional method, each body part of the seam is welded in the overlap region and then a thick coating is used to level the seam with the edge portions of the overlapping sheets by applying a high-temperature wire arc sprayed coating. The wire arc spraying process typically uses an arc temperature of approximately 2,500° C. to create molten droplets that must be propelled toward the substrate at a velocity greater than 100 meters per second to form an acceptable coating. The density of a wire arc sprayed coating is lowered due to elevated porosity within the coating.

The seam is then polished down flush with the body panels by means of grinding-polishing steps that often require manual labor. The quality of the ensuing painting process relies on these final steps used to finish the seam. This multi-step process is both costly and time consuming. Porosity, or unfilled voids, in coatings deposited by wire arc spraying results in inner stress and cracking of the coating. Solvent fills the voids during the primer application and evaporates during the paint baking operations, leading to the formation of solvent pops in the surface which adversely affects the appearance and durability of the clearcoat.

A lower temperature gas-dynamic coating deposition technology has been disclosed in U.S. Pat. No. 5,302,414. That technique has been essentially improved in U.S. Pat. No. 6,402,050 and applied to depositing metal-ceramic coatings in [RU 2183695, PST RU 0100350] and [RU 2001135048, PCT RU 02 00543]. However, current methods have not been successfully developed to produce a thick level coating that is both corrosion resistant and highly dense to provide sealing effect and eliminate pops developing during paint baking process.

What is needed is a method of forming a dense coating that can be applied through an automated process to provide corrosion protection and a level seam on welded or overlapping automotive panels, that is compatible with further painting, and that also provides a sealing effect.

### SUMMARY OF THE INVENTION

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

The present invention is directed to the use of a gas dynamic spraying method to produce a dense coating that provides good sealing characteristics, corrosion resistance and is fully compatible with the painting process. The present invention thereby provides a method of producing such coatings in an automated process. In one aspect of the present invention, a welded lap joint or hem flange is coated with a mixture of powder inorganic materials containing metallic and ceramic components. The coating process utilizes a gas dynamic spraying method in which a jet of compressed air is pre-heated to a range of 100° C. to 700° C. This pre-heated air is then fed into a supersonic nozzle to produce an air jet. The powdered inorganic materials are then fed into the nozzle to mix with the air jet and produce a powder laden air jet which is sprayed onto the work surface. The resulting powder laden air jet is at a temperature that is below the thermal softening point of the powder constituents. The powder constituents are chosen for a particular application to produce a coating that possesses high adhesion to the substrate. These coatings are also durable with high repeatability characteristics. Because of high velocities and relatively low deposition temperatures, no oxidation of the particles takes place. Various combinations of metallic and ceramic constituents can be deposited in one technological process. The coatings also improve the strength of the lap joints and hem flanges and are fully compatible with the ensuing painting process.

Some of the powder constituents will not bond with the work surface and these individual powder granules can be recovered and recycled into the process. By using a method that does not melt the materials that form the coating, reusable powder can be recovered. While the exact composition of the recovered powder may not be known, this powder can be used in applications that accept a varying composition of powder to form an acceptable coating.

While dense coatings, including those with anticorrosion properties, are desirable for all exposed metal surfaces, specific applications are automotive roof seams and various airplane components/body panels. Multiple applications of the coating can provide filler material for C pillar welded joints, panel dents, spot weld filler, aluminum body repair, heat resistant coatings, restoration of metal parts, molds, threaded bolts and nuts, and commercial logos and emblems.

Additionally, the coatings can be used for surface and dimension restoration and sealing pipe and tube joints and welds. Both the inner and outer pipe/tube surfaces can be protected with the coating process. In another aspect of the present invention, an anodized surface can be repaired in a localized, dry process. Using this method, a mixture that includes zinc, or other appropriate materials, can be powder sprayed to form an anodized coating on a surface. This process is superior to a wet anodized process in that the area to be coated can be precisely controlled and aqueous solutions are not required, resulting in less waste.

In another aspect of the present invention, castings are produced for engine-drivetrain uses. These castings include transmission housings, engine blocks, transfer cases, front and rear axle housings, oil pans, cylinder heads and radiators. Occasionally, porosity develops in these components to the extent that the component can leak but be otherwise acceptable for its intended use. A low viscosity, resin-based sealant can be applied to these components to correct these leaks, but the sealant does not work on larger pores and cracks and is very time consuming. The powder laden jet coating process of the present invention has been successful in efficiently sealing these leaks.

In yet another aspect of the present invention the process can be reliably built into a fully automated manufacturing line. A robotic process can be utilized to deposit a coating onto a body panel seam in a manner that produces a thick, level, finished surface requiring almost no manual finishing.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a lap joint having a seal formed in accordance with the principles of the invention.

FIG. 2 is a cross-sectional view of a hem flange having a seal formed in accordance with the principles of the invention.

FIG. 3 is a cross-sectional view of the nozzle used in the present invention.

FIG. 4 is a schematic of the gas dynamic spraying apparatus used with the nozzle of FIG. 3.

### DETAILED DESCRIPTION OF THE PREFERRED EMBODIMENTS

The following description of the preferred embodiments is merely exemplary in nature and is in no way intended to limit the invention, its application, or uses.

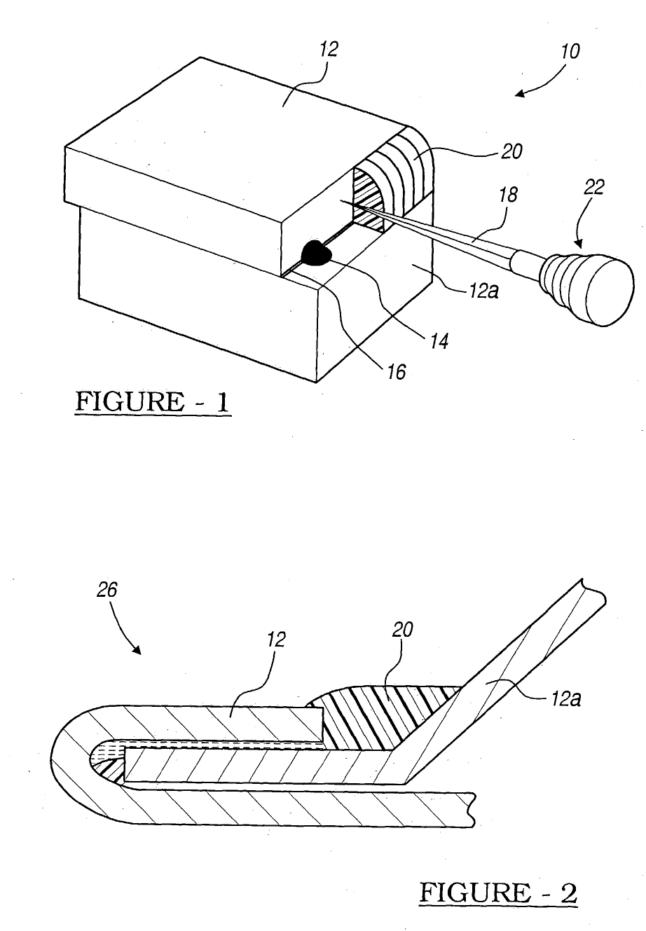

Referring to FIG. 1, a lap joint 10 is formed by placing a first metal body panel 12 adjacent at least one second panel 12a so that their thicknesses are aligned. Typically, spot welds 14 are used to hold the panels in place until weld 16 can be applied. In the preferred embodiment, weld 16 is a metal inert gas weld, although it is recognized by those skilled in the art that various types of welding methods may be substituted.

According to the present invention, a powder laden jet 18 of a gas-metal-ceramic mixture is sprayed onto the lap joint 10 to form a coating 20 which will be described in more detail hereinafter. Apparatus 22 propels and directs powder laden jet 18 onto lap joint 10, preferably at a speed of 350 to 1,200 meters per second.

With reference to FIG. 2, hem flange 26 is formed by bending an edge of a first panel 12 over an edge of a second panel 12a. Coating 20 is formed in a manner similar to the above described method. While preferred applications of the method of the present invention include hem flanges, lap joints and casting leaks, it should be understood that other applications requiring a smooth, corrosion resistant, or sealing coat would be an obvious variation of this method.

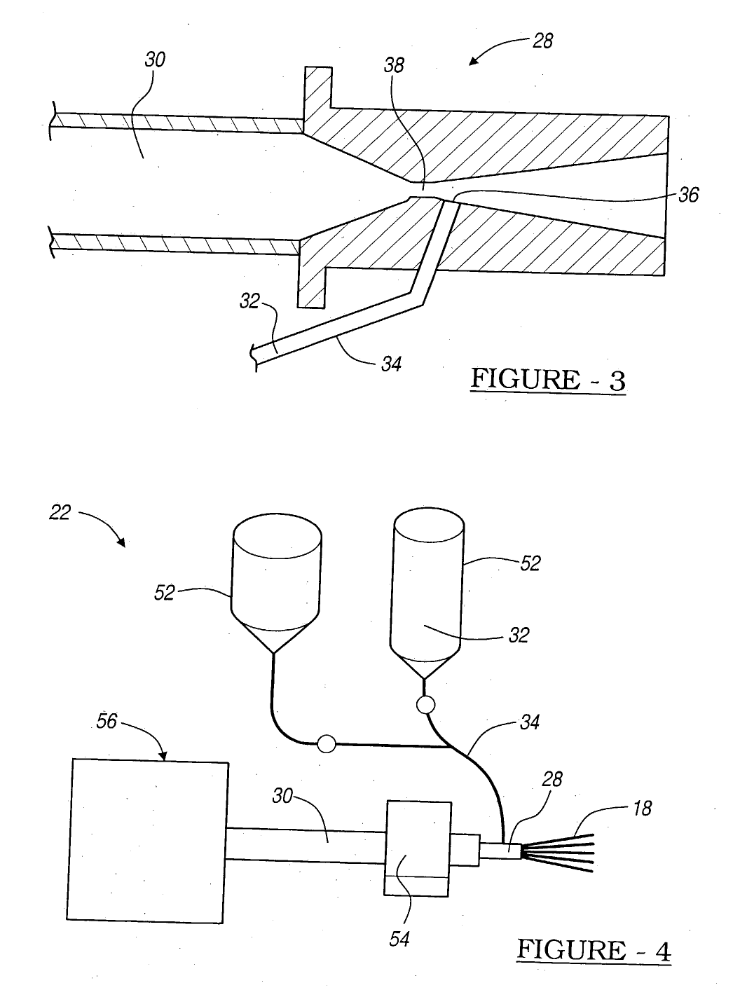

FIG. 3 shows a nozzle 28 of the present invention. Gas stream 30 is preferably at supersonic velocity within nozzle 28. The formed jet creates a suction, or venturi effect, to draw powder 32 from powder supply line 34. Powder inlet 36 is preferably downstream of throat 38 of nozzle 28 and is adjustable in aperture to regulate the flow of powder.

With reference to FIG. 4, spraying system apparatus 22 is shown to include powder hopper 52 in communication with powder inlet 36 (FIG. 3) of nozzle 28 via powder supply line 34. Multiple powder hoppers 52 with various valving/metering devices can be used to supply the desired composition of powder 32 to powder inlet 36. Gas stream 30 is forced through heater 54 then nozzle 28 by gas supply 56. Powder laden jet 18 is formed due to the mixing of powder 32 and gas stream 30. Powder laden jet 18 forms coating 20 (FIGS. 1 and 2) as powder laden jet 18 is deposited onto the desired substrate.

The composition of powder 32 depends on the application the coating is intended for. A preferred composition of powder 32 is a mechanical mixture of metal and ceramic particles with a diameter of less than 100 microns. Preferably, powder 32 includes between 5 and 90 weight percent ceramics. Metal particles, in particular aluminum, are necessary to obtain a good bonding strength in mainly thick coatings. Ceramic particles are essential to obtain good bonding strength in all types of coatings.

A preferred composition of powder 32 for an anti-corrosion coating includes: Al in a range of 1 to 15 weight percent, Zn in a range of 40 to 60 weight percent, and SiC in a range of 45 to 65 weight percent.

A preferred composition of powder 32 for material build up purposes includes: Al in a range of 45 to 65 weight percent, Zn in a range of 10 to 30 weight percent and SiO2 in a range of 15 to 35 weight percent.

A proven preferred composition for powder 32 useful in sealing coatings includes: Al in a range of 20 to 40 weight percent, Zn in a range of 35 to 55 weight percent and Al2O3 in a range of 5 to 25 weight percent.

A preferred composition of powder 32 for local anodizing or repair of anodized coatings includes: ceramics in a range of 5 to 90 weight percent and Zn in a range of 10 to 95 weight percent.

Although the above mentioned preferred compositions are satisfactory for the intended purposes, many mixtures of powder 32 including metals, metal-oxides, alloys and ceramics will demonstrate some of the desired characteristics of a dense coating. A non-exhaustive list of constituents for powder 32 includes the materials listed in Table 1.

TABLE 1

| Metals | Alloys | Ceramics |
|---|---|---|
| Aluminum (Al) | Cu—Al | Al2O3 |
| Silver (Ag) | Cu—Zn | AlN |
| Copper (Cu) | Cu—Sn | Al4C3 |
| Zinc (Zn) | Al—Si | B4C |
| Titanium (Ti) | Al—Mg | BN |
| Nickel (N) | Fe—Al | B203 |
| Iron (Fe) | Ni—Ag | SiO2 |
| Chromium (Cr) | Al—Mg—Si | SiC |
| Magnesium (Mg) | Al—Mg—Cu | Si3N4 |
| | Al—Cu—Mg—Si | TiC |
| | Al—Zn—Cu—Mn | TiN |
| | Al—Cu—Mg—Mn | Zr02 |
| | Brazing alloys | WC |

A desired characteristic of the method of the present invention is to maintain the temperature of powder laden jet 18 below the thermal softening point of powder 32. The preferred temperature range for powder laden jet 18 is 100° to 700° C. In this manner, the particles of powder 32 are not in a molten state and are available to plastically deform upon impact and bond with the substrate resulting in a uniform, dense coating.

In order to further illustrate the present invention, four non-limiting examples are set forth below.

### EXAMPLE 1

C-pillar cutouts (roof/quarter) were used for testing the compatibility of the coating with the painting process.

To smooth out the edges of the overlapping panels, a 2 mm thick gas dynamic coating has been applied, instead of the traditional, high temperature wire arc sprayed (so-called spray braze) coating. The powder composition of the sprayed material was: Al_{(45-65)Wt %} Zn_{(10-30)Wt %} SiO2_{(15-35)Wt %} with average grain size about 50 μm.

The cutouts were finished to a paintable surface and put through a complete painting process. No pops have been observed on the painted surfaces.

To assess the adhesion of the paint film to gas dynamic coatings, a tape test method was used, consisting of applying and removing pressure-sensitive tape over a lattice pattern of six cuts in each direction made in the film. Adhesion was assessed qualitatively on a 0 to 5 scale. Result: Adhesion was rated at 5, the best rating that can be obtained using this method.

### EXAMPLE 2

C-pillar cutouts were used to evaluate the corrosion resistance of painted gas dynamic coatings.

The cutouts were subjected to a chipping corrosion test. The cutouts were baked for 60 minutes at 140° F. and allowed to cooled for 30 minutes, then immersed in the aqueous solution of 5 wt % NaCl (pH 6.5 to 7.1) for 15 minutes, removed and air dried for 75 minutes. Then daily the cutouts were placed in a humidity cabinet set at 140° F. and 85% relative humidity for 23 hours. Twenty five test cycles were completed.

The same tests have been performed on C-pillar cutouts coated by the high temperature spray braze process and subsequently painted.

By visual examination of the physical state of the gas dynamically sprayed cutouts at the end of the cyclic corrosion test period, no changes in panels appearance were found, while the spray braze coated cutouts showed a considerable degree of paint blistering all over the coated area.

### EXAMPLE 3

A cast iron engine block 3.3L was used for testing the durability of the gas dynamic coatings.

Three holes, 1 mm in diameter each, were drilled in exterior cylinder wall water jacket, high pressure oil outlet line and water pump housing/timing chain cover. A powder composition Al_{(20-40)Wt %} Zn_{(30-55)Wt %} Al2O3_{(5-25)Wt %} with an average grain size about 50 μm was used to form 0.5×0.5 inch coatings-patches over each of the holes. The engine was built up and subjected to Deep Thermoshock test (1000 cycles/330 hours, engine speed 0-5,000 rpm, engine temperature −40° F. to +250° F., 100% throttle condition for the duration of testing). No damage to the coatings were detected after completion of the test.

### EXAMPLE 4

Assemblies consisting of a section of automotive fuel line (stainless steel tubes ⅜″ in diameter and 12 inches long) and a 90° (“elbow”) stainless steel quick connects were used to test the sealing properties of the gas dynamic coatings.

Each assembly was mechanically fitted together into a tight joint. The spraying gun was fixed at a distance of 1/2 inch from the joint. Each assembly was rotated at a constant speed about 60 rev/min while the joint was sprayed. The formed ring-coating were about 2 mm thick and 10 mm wide. The sprayed powder compositions were the same as in Example 3. The gas dynamically sealed assembles were subjected to an under water leak test. Tests were conducted at hydraulic pressures of 1500 and 2000 psi for 3 minutes. No leakages of the sealed joints were detected. After that a radial 30 N-m torque was applied to the sealed fitting while the tubing was squeezed in the vise at about 1 inch distance from the joint. Then a second underwater leak test at 1500 psi was conducted. No leakage was detected. The measured axial pull-out force for the sealed joints was in excess of 2840 N.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of applying a coating to a work surface, the method comprising:
supplying a pre-heated gas flow though a supersonic nozzle;
feeding a powder through an adjustable inlet into said gas flow downstream of a throat of the nozzle to form a powder-laden jet, the powder including at least one material selected from the group consisting of metals, alloys, and steel and further including at least one material selected from the group consisting of ceramics and metal oxides; and
directing said powder-laden jet onto a work surface so that a coating of said powder is formed on the work surface.

2. The method of claim 1, wherein the pre-heated gas comprises at least one constituent selected from the group consisting of air, argon, helium, hydrogen, nitrogen, oxygen and mixtures.

3. The method of claim 1, where said pre-heated gas has a temperature sufficiently low so as to prevent thermal softening of said powder.

4. The method of claim 1, wherein said pre-heated gas has a temperature range of 100° C.-700° C.

5. The method of claim 1, wherein said powder has a particle size of 0.01-100 microns.

6. The method of claim 1, wherein said powder-laden jet has a velocity in a range of 350-1200 meters per second.

7. The method of claim 1, wherein the step of directing said powder-laden jet onto said work surface results in a uniform coating.

8. The method of claim 1, wherein said adjustable inlet has a variable internal diameter from 0 to 5 millimeters.

9. The method of claim 1, wherein at least a portion of said powder bonds to said work surface.

10. The method of claim 1, wherein at least a portion of said powder metallurgically bonds to said work surface.

11. The method of claim 1, wherein said gas flow creates a sufficient suction to draw the powder through the inlet.

12. The method of claim 1, wherein said powder includes at least one material selected from the group consisting of: Al, Ag, Cu, Zn, Ti, Ni, Fe, Cu—Al, Cu—Zn, Cu—Sn, Al—Si, Al—Mg, Fe—Al, Ni—Ag, Al—Mg—Si, Al—Mg—Cu, Al—Cu—Mg—Si, Al—Zn—Cu—Mn, Al—Cu—Mg—Mn, amorphous aluminum, babbit, brazing alloys and steel, and at least one material selected from the group consisting of: Al2O3, AlN, Al4C3, B4C, BN, B2O3, SiO2, SiC, Si3N4, TiC, TiN, WC, ZrO2 and PZT.

13. The method of claim 1 wherein said powder includes 5 to 90 weight percent ceramics.

14. The method of claim 1, wherein said coating of powder on said work surface is sufficient to form a sealing coat, and wherein said powder includes:
Al in a range of 20 to 40 weight percent,
Zn within a range of 35 to 55 weight percent, and
Al2O3 within a range of 5 to 25 weight percent.

15. The method of claim 1, wherein said coating forms a thick material buildup ranging from 10 microns to 1 inch in thickness.

16. The method of claim 15, wherein said powder includes:
Al in a range of 45 to 65 weight percent,
Zn in a range of 10 to 30 weight percent, and
SiO2 in a range of 15 to 35 weight percent.

17. The method of claim 1, wherein said coating is sufficient to form an anticorrosion coating, and wherein said powder includes:
Al in a range of 1 to 15 weight percent,
Zn in a range of 40 to 60 weight percent, and
SiC in a range of 45 to 65 weight percent.

18. The method of claim 1 wherein said coating is directed to local anodizing or to repair an anodized coating, wherein said powder includes:
Zn in a range of 10 to 95 weight percent, and
ceramics in a range of 5 to 90 weight percent.

19. A method of applying a coating to a surface of the article, the method comprising:
supplying a pre-heated to a temperature 350-700° C. compressed gas into a supersonic nozzle,
forming a supersonic gas stream downstream of the nozzle throat,
feeding a powder into said supersonic gas stream,
accelerating said powder in the nozzle, so that a powder laden jet is formed;
said powder including a mechanical mixture of Al and Zn powders,
said powder further including at least one material selected from the group consisting of ceramics and metal oxides in amount of 20-50% of the total weight of said powder;
said mechanical mixture consist of: Al in a range of 20 to 40 weight percent of the total weight of said mechanical mixture, Zn within a range of 60 to 80 weight percent of the total weight of said mechanical mixture,
and directing said powder laden jet onto a surface of the article so that a coating of said powder is formed on said surface.
